(19) United States
(12) Patent Application Publication
(10) Pub. No.: US 2018/0137448 A1
(43) Pub. Date: May 17, 2018

(54) SYSTEM AND METHOD FOR DYNAMIC ONGOING DISCOVERY OF HIGH POTENTIAL RESEARCH PROBLEMS IN AN ENTERPRISE

(71) Applicant: International Business Machines Corporation, Armonk, NY (US)

(72) Inventors: Pritpal S. Arora, Bangalore (IN); Bijo S. Kappen, Karnataka (IN); Gopal S. Pingali, Mohegan Lake, NY (US); Adinarayana Sakala, Tirupati (IN)

(21) Appl. No.: 15/353,832

(22) Filed: Nov. 17, 2016

(51) Int. Cl. G06Q 10/06; G06Q 50/00

(52) U.S. Cl. CPC G06Q 10/06375; G06Q 50/01

(57) ABSTRACT

The present invention is a system and method for dynamic ongoing discovery of high potential research problems in an enterprise. The system includes a computer processor with a non-transitory memory, a master rapid value generator database, and a research potential tracker computing module. The system groups subsets of research problems based upon predetermined similarities amongst them, computes a business value and research potential index for each subset, compares each research potential index against a predetermined research potential threshold, and determines one or more stakeholders within the enterprise if the research potential index exceeds said predetermined research potential threshold.

### BACKGROUND

### 1. Field of the Invention

The present invention relates generally to a system and method for detecting problems in an enterprise, and more particularly to a method and system for dynamic ongoing discovery of high potential research problems in an enterprise.

### 2. Background of Art

The conventional approach to solving problems in an enterprise is to have management discussions and planning cycles leading to research investments. These planning cycles can bring considerable thought and judgment and extend the cycle of planning and investment. However, they are not dynamically adaptive to the continuous changes in the marketplace, client needs, and business needs. Another common approach is an innovation jam to gather talent across and beyond the enterprise to engage clients and partners to identify problems and challenges of high interest to them, thereby identifying areas for investing in research and development, and possibly forming research groups. However, innovation jams are one-time events focused on one specific area of research. Thus, they do not enable continuous adaption to business and market needs on an ongoing basis, nor do they cover the broad spectrum of all research areas relevant to an enterprise.

Social media mechanisms, such as innovation blogs, enable members of an enterprise to post research and other innovation challenges of interest. Other members in the enterprise are permitted to suggest solutions and let others in the enterprise rate and rank the solutions. However, these mechanisms are subject to limitations. First, they cover a wide range of problems. They cover problems having existing solutions and assets, which simply need to be pointed out to the requester. They also include quick new suggestions that need to be made and on the other hand, they also include deep research problems. Thus, there is no systematic way of identifying and culling out the problems that are research grade problems worthy of investment. Second, social media mechanisms do not automatically identify research groups to work on problems; therefore, research groups are not tied into the research investment and prioritization processes. Social media mechanisms depend more on ad hoc bottom-up innovation with limited recognition by management, usually only through group ratings.

In a related invention, a socio-technical system for rapid value creation was introduced. The system enables anyone in an enterprise to identify an opportunity, associate an enterprise value, reward, and time frame the opportunity. While the socio-technical system involves multiple people across an enterprise to rapidly create value and rewards contributors in proportion to their contribution and speed of contribution, it is limited in its ability to identify high potential research problems, identify potential research groups, and tie the research problems and groups to research investment and prioritization processes.

Therefore, there still exists a need for a system and method for identifying research problems in an enterprise rapidly within the time frame associated with opportunities, grouping opportunities, and validating a value for clusters of similar unsolved opportunities.

It is a principal object and advantage of the present invention to provide continuous identification of valuable opportunities to an enterprise.

It is another object and advantage of the present invention to filter out opportunities appearing in multiple iterations yet remaining unsolved.

It is yet another object and advantage of the present invention to filter out opportunities having a time frame which is expired or near expiration.

It is a further object and advantage of the present invention to match opportunities with stakeholders in the enterprise based on the research area associated with the opportunity.

It is an added object and advantage of the present invention to identify potential contributors to an opportunity.

It is yet another object and advantage of the present invention to determine an overall business value for a group of similar opportunities.

Other objects and advantages of the present invention will in part be obvious and in part appear hereinafter.

### SUMMARY

The present invention is a system and method for dynamic ongoing discovery of high-potential research problems in an enterprise. The system includes a computer processing system including a computer processor having a non-transitory memory, a master rapid value generator database, and a research potential tracker computing module. The master rapid value generator database is in operative communication with the computer processor and stores data representative of a plurality of research problems, such as predetermined values associated with each research problem and predetermined time frames associated with each research problem.

The research potential tracker computing module is also in operative communication with the computer processor and the master rapid value generator database. The research potential tracking computing module comprises computer code for: (1) grouping a subsets of research problems based upon predetermined similarities amongst them, (2) computing a business value and research potential index for each subset, (3) comparing each research potential index against a predetermined research potential threshold, and (4) determining one or more stakeholders within the enterprise if the research potential index exceeds the predetermined research potential threshold.

The method for dynamic ongoing discovery of high-potential research problems in an enterprise includes the step of grouping subsets of research problems based upon predetermined similarities amongst them. The method also includes the steps of removing a research problem from a subset when the research problem has a time frame extending beyond a predetermined time frame threshold, computing a business value and research potential index for each subset, comparing each research potential index against a predetermined research potential threshold, and determining one or more stakeholders within the enterprise if the research potential index exceeds the predetermined research potential threshold.

### BRIEF DESCRIPTION OF THE DRAWINGS

The present invention will be more fully understood and appreciated by reading the following Detailed Description in conjunction with the accompanying drawings, in which:

FIG. 1 is a diagram of a non-limiting illustrative embodiment of the system according to the present invention;

FIG. 2 is a flow chart of a non-limiting illustrative embodiment of a method for grouping subsets of research problems based on predetermined similarities amongst them;

FIG. 3 is a flow chart of a non-limiting illustrative embodiment of a method for computing a business value and research potential index for each subset of research problems;

FIG. 4 is a flow chart of a non-limiting illustrative embodiment of a method for confirming the value of an opportunity with the stakeholders of an enterprise;

FIG. 5 is a flow chart of a non-limiting illustrative embodiment of a method for method for creating and updating a research challenge database; and

FIG. 6 is a flow chart of a non-limiting illustrative embodiment of a method for computing a business value cluster score for each problem cluster.

### DETAILED DESCRIPTION

Referring to the Figures, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

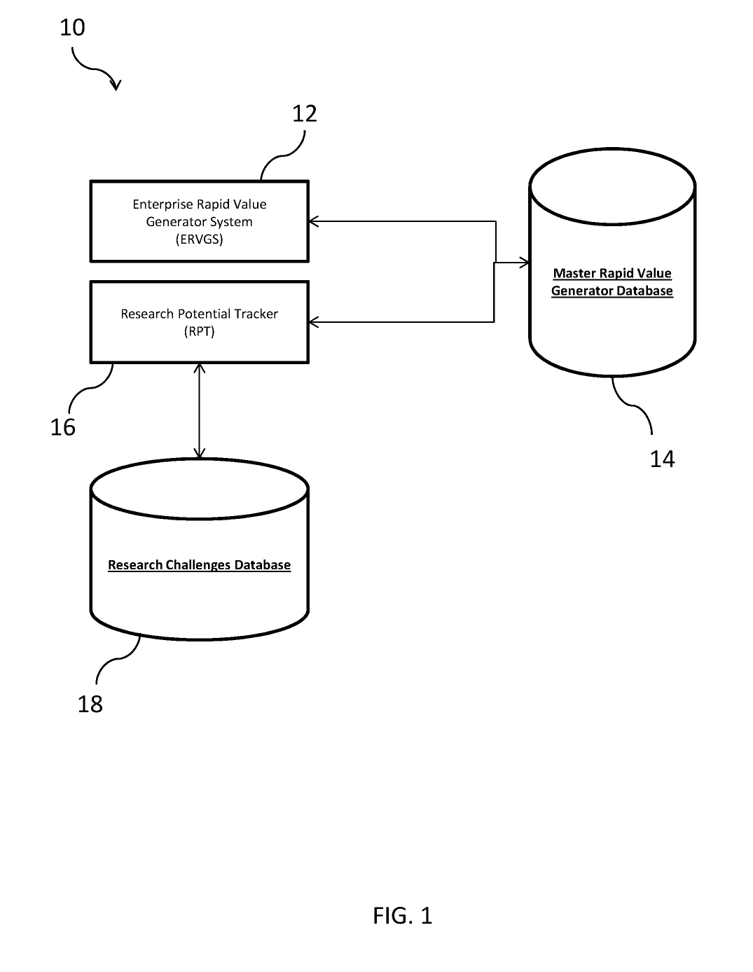

Referring again to the drawings, wherein like reference numerals refer to like parts throughout, there is seen in FIG. 1 a diagram of a non-limiting illustrative embodiment of the system according to the present invention. The system is a computer processing system 10 comprising an enterprise rapid value generator system (ERVGS) 12 in operative communication with a master rapid generator database 14 and a research potential tracker (RPT) computing module 16. The RPT computing module 16 is also in operative communication with a research challenge database 18. Each component is further in operative communication with a computer processor having a non-transitory memory. The ERVGS 12 syncs enterprise opportunities with the master rapid generator database 14, categorizing each opportunity according to a problem ID, problem statement, proposal value, time limit, and reward value. The RPT computing module 16 obtains enterprise opportunities having a time limit that exceeds a predetermined time frame threshold. The RPT computing module 16 transmits data representative of aspects of each research problem or challenge to the research challenge database.

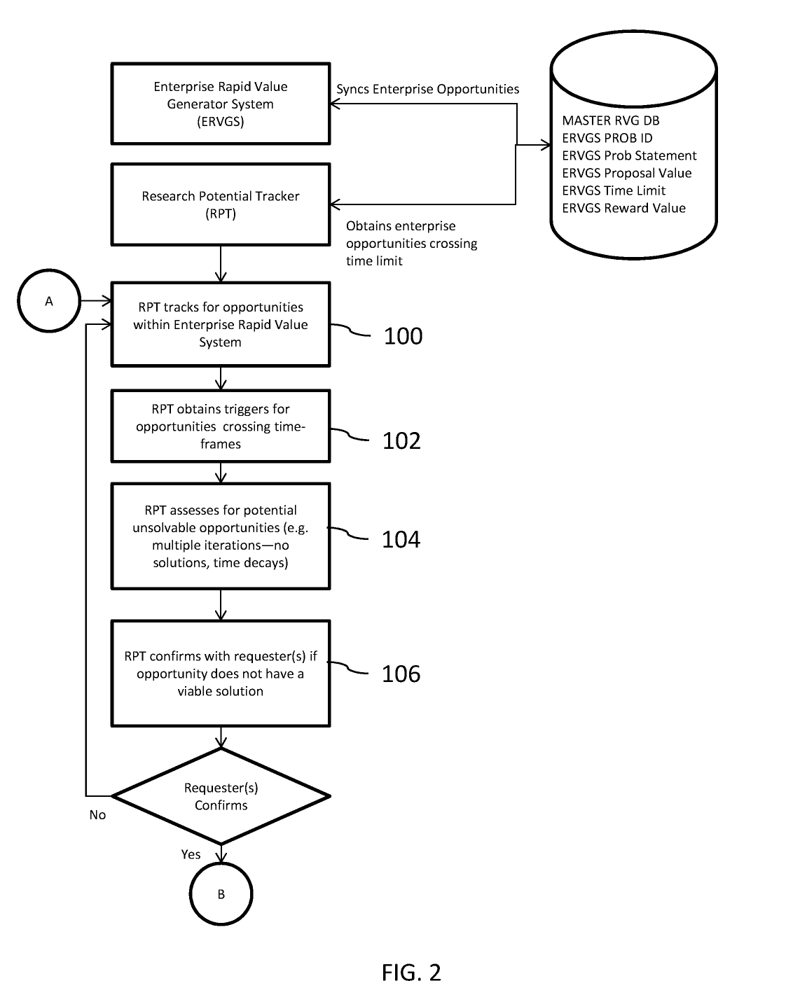

Referring now to FIG. 2, there is shown a flow chart of a non-limiting illustrative embodiment of a method for grouping subsets of research problems based on predetermined similarities amongst them. At the first step 100, the RPT computing module 16 continuously searches for opportunities within the ERVGS 12. The RPT computing module 16 comprises computer code for detecting opportunities having an assigned time limit which exceeds a programmed time frame threshold. At the next step 102, the RPT computing module 16 receives an alert for opportunities having a time limit that extends beyond the programmed time frame threshold. Thus, the RPT computing module 16 limits the pool of opportunities by determining whether each opportunity can be explored and researched within a given time frame.

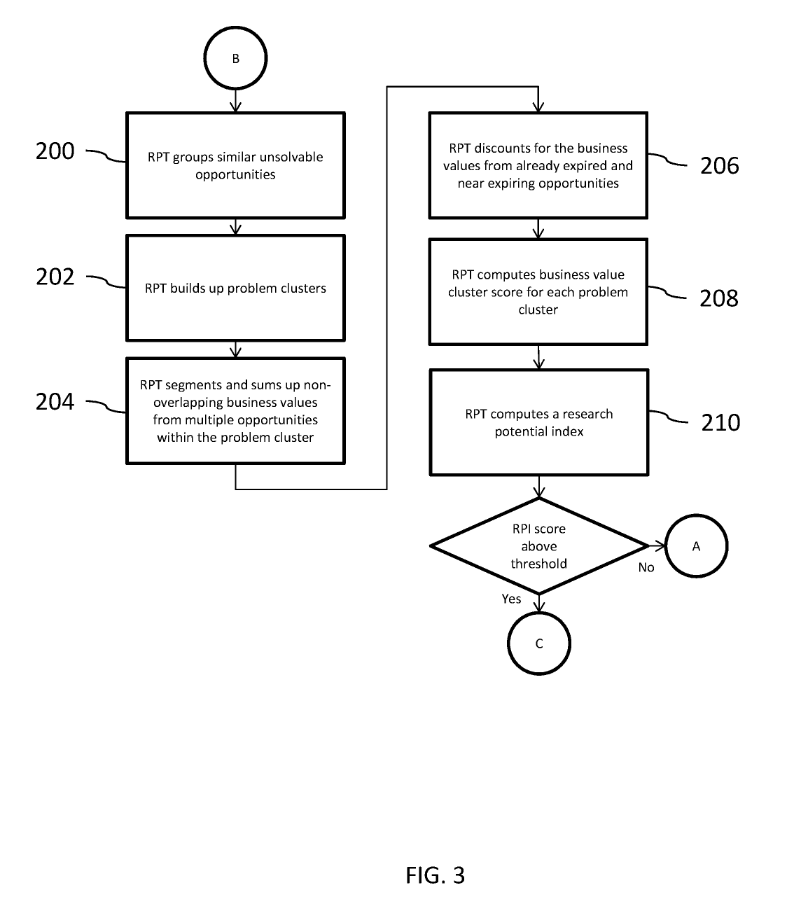

Still referring to FIG. 2, at the following step 104, the RPT computing module 16 assesses the opportunities to determine the potential for solving the opportunities. The RPT computing module 16 comprises computer code with an algorithm weighing factors such as time decay and whether there have been multiple iterations of the same opportunity without a solution, for example. At the final step 106 of the embodiment shown in FIG. 2, the RPT computing module 16 confirms with the user that the opportunity does not have a viable solution. The user may confirm, on a terminal of the computer processing system, for example, that the opportunity does not have a viable solution. If the opportunity has a viable solution, the method repeats again, starting at the first step 100. If the user confirms the opportunity does not have a viable solution, the next step in the method, shown in FIG. 3, is initiated.

Referring now to FIG. 3, there is shown a flow chart of a non-limiting illustrative embodiment of a method for computing a business value and research potential index for each subset of research problems. At the first step 200, the RPT computing module 16 groups similar unsolvable opportunities. The unsolvable opportunities can be grouped by comparing keywords and descriptions associated with the opportunities using a searching mechanism, such as a natural language processing (NLP) engine. The opportunities can also be grouped according to structured fields or tags denoting the technical area and/or business unit associated with the opportunity. At the next step 202, the RPT computing module 16 builds up problem clusters. As the unsolvable opportunities are grouped, the groups are segregated into problem clusters which represent a subset of all the research problems.

At the following step 204, the RPT computing module 16 segments and sums non-overlapping business values from multiple opportunities within the problem cluster. At the subsequent step 206, the RPT computing module 16 discounts the sum of business values for the business values of expired and near expiring opportunities. Each opportunity has a predetermined business value associated with it when it is entered into the ERVGS 12 and stored within the master rapid value generator database 14. At this step 206 and the previous step 204, an algorithm executed by the processor analyzes the data associated with each opportunity in the problem cluster and determines if the business value for each opportunity is for a different client, segment, or region. If there is overlap, such as if the business values of two opportunities are for the same client, the algorithm does not double count the business values. As an alternative to double-counting, the algorithm selects the greater business value. Thus, the algorithm ensures opportunities associated with the same regions, clients, or industries are not overvalued because the opportunities are so similar. Therefore, if some overlap exists, the non-overlapping portions are summed, while each overlapping portion is added only once to calculate the business value cluster score, shown in the next step 208.

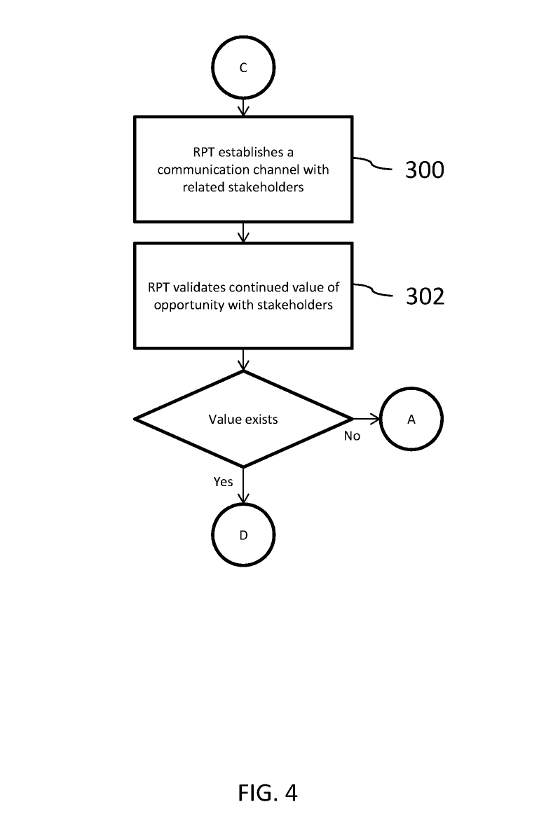

At the following step 210, the RPT computing module 16 computes a research potential index (RPI). The RPI for each problem cluster is a weighted function dependent on key data associated with the opportunities and attempted solutions against the opportunities in the problem cluster. The RPI for each cluster is a function of the following data: (1) the overall business value associated with the cluster; (2) the extent of effort expended toward the opportunities in the cluster; (3) the ratings and reputation of the contributors to the opportunities in the cluster; and (4) the gap between the expected and existing ratings. A higher RPI is correlated to a higher overall business value, a higher effort expended towards opportunities, higher ratings and reputation of contributors, and a larger gap between expected and existing ratings. If the RPI is above a programmed threshold, the next step of the method, shown in FIG. 4, is initiated. A compare algorithm with a programmed threshold value is used to determine whether the RPI is high enough to proceed to the next step of the method. The threshold value can be a preprogrammed default value or a configurable parameter set for a particular scenario or organization. The system may also update a default threshold value based on the typically manually configured parameter, i.e. the threshold is learned and fine-tuned over time.

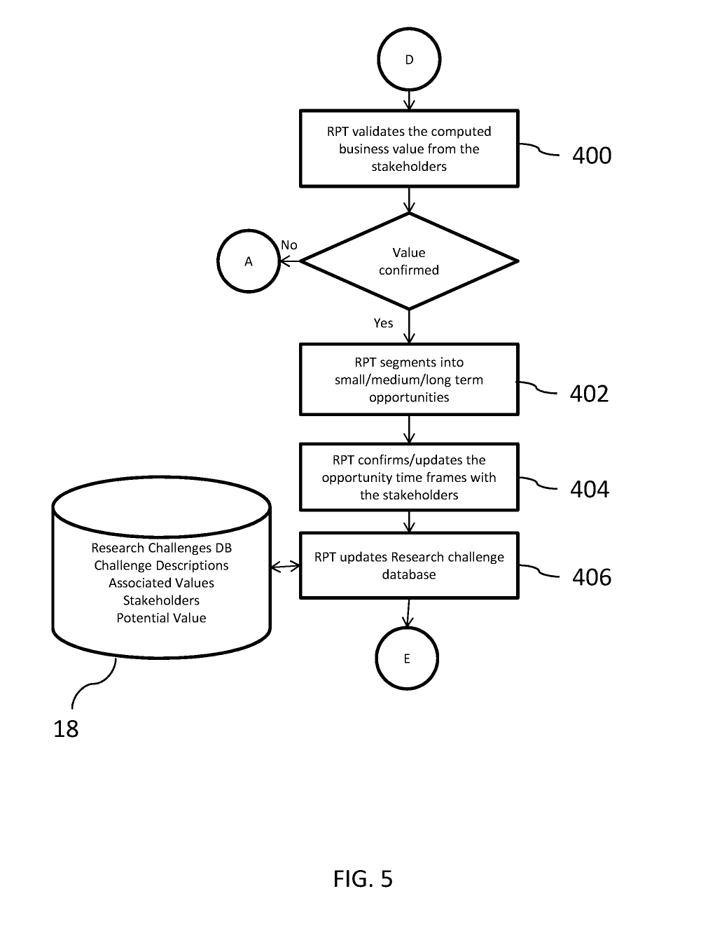

Referring now to FIG. 4, there is shown a flow chart of a non-limiting illustrative embodiment of a method for confirming the value of an opportunity with the stakeholders of an enterprise. At the first step 300, the RPT computing module 16 establishes a communication channel with related stakeholders. The communication channel can be one or more channels based on the preferences of the stakeholders or the default for an organization. The channels may include email, text message, an automated phone call, an instant message, or a social media notification, for example. At the next step 302, the RPT computing module 16 validates the continued value of an opportunity with the stakeholders via the communication channel. If the value for the opportunity is not confirmed by the stakeholders, the method is repeated starting at the first step 100 shown in FIG. 1. If the stakeholders agree that a value exists for the opportunity, the next step of the method, shown in FIG. 5, is initiated.

Referring now to FIG. 5, there is shown a flow chart of a non-limiting illustrative embodiment of a method for creating and updating a research challenge database 18. At the first step 400, the RPT computing module 16 validates the computed business value with the stakeholders via the communication channel. If the computed business value for the opportunity is not confirmed by the stakeholders, the method is repeated starting at the first step 100 shown in FIG. 1. If the stakeholders confirm the computed business value, the next step 402 of the method is initiated. At this step 402, the RPT computing module 16 segments opportunities into three time frame categories: small-term, medium-term, and long-term opportunities. At the following step 404, the RPT computing module 16 confirms and updates the opportunity time frames with the stakeholders. Once the RPT computing module 16 has confirmed and updated the opportunity time frames, at the next step 406, the RPT computing module 16 updates the research challenge database 18. The research challenge database 18 stores the time frame information for each opportunity. The research challenge database 18 also stores other information, such as challenge descriptions, associated values, stakeholders, and potential values, for example.

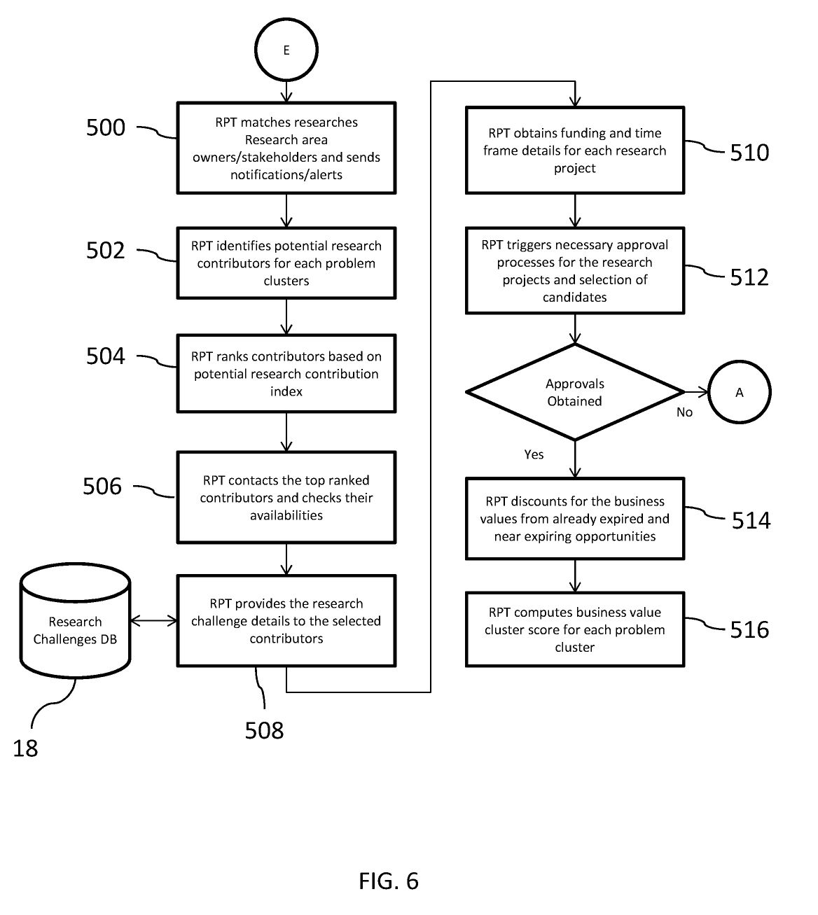

Referring now to FIG. 6, there is shown a flow chart of a non-limiting illustrative embodiment of a method for computing a business value cluster score for each problem cluster. At the first step 500, the RPT computing module 16 matches an opportunity with research based on the most appropriate research area stakeholders and sends an alert to the stakeholders notifying them of the emergence of the opportunity. In the next step 502, the RPT computing module 16 identifies potential research contributors for each problem cluster. It does this by scanning a list of contributors who previously worked on opportunities in the problem cluster and computing a potential research contribution index for each contributor based on: (1) effort expended by the contributor thus far on opportunities in the problem cluster, (2) the reputation of the contributor, and (3) the skill area of the contributor in relation to the skill areas needed for the opportunity. In the following step 504, the RPT computing module 16 ranks contributors based on a potential research contribution index. In the next step 506, the RPT computing module 16 contacts the top ranked contributors and checks their availabilities and willingness to work on the opportunity. At the subsequent step 508, the RPT computing module 16 provides the research challenge data from the research challenge database to the top-ranked contributors.

Still referring to FIG. 6, at the next step 510, the RPT computing module 16 obtains funding and time frame details from the stakeholders for each research project. At the following step 512, the RPT computing module 16 triggers the necessary approval processes for the research project and selection of candidates from the stakeholders. If the approvals are not obtained, the method repeats starting at the first step 100 shown in FIG. 1. If the approvals are obtained, then at the next step 514, the RPT computing module 16 discounts for the business values from expired and near expiring opportunities. Finally, at the last step 516, the RPT computing module 16 computes a business value cluster score for each problem cluster. As each opportunity has been categorized by a time frame, as seen in a previous step 400 in FIG. 5, the algorithm executed by the processor applies a decay function to the business values. The decay function is used to determine the value of an opportunity in a time frame of interest, i.e. a weighted business value representing the overall business value score for each problem cluster.

While embodiments of the present invention has been particularly shown and described with reference to certain exemplary embodiments, it will be understood by one skilled in the art that various changes in detail may be effected therein without departing from the spirit and scope of the invention as defined by claims that can be supported by the written description and drawings. Further, where exemplary embodiments are described with reference to a certain number of elements it will be understood that the exemplary embodiments can be practiced utilizing either less than or more than the certain number of elements.

1. A computer processing system for dynamic ongoing discovery of research problems in an enterprise, comprising:
a computer processor having non-transitory memory;
a master rapid value generator database in operative communication with said computer processor and comprising data representative of: a plurality of research problems;
respective, predetermined values associated with each of said plurality of research problems; and respective, predetermined time frames associated with each of said plurality of research problems;
a research potential tracker computing module in operative communication with said computer processor and said master rapid value generator database, comprising computer code for:
grouping a plurality of subsets of said plurality of research problems based upon predetermined similarities amongst them;
computing a business value and research potential index for each said subset;
comparing each said research potential index against a predetermined research potential threshold;
determining one or more stakeholders within said enterprise if said research potential index exceeds said predetermined research potential threshold.

2. The system of claim 1, wherein the research potential tracker further comprises code for:
grouping said plurality of research problems in each subset based upon a time frame category.

3. The system of claim 1, wherein the research potential tracker further comprises code for:
matching each research problem in each subset with said one or more stakeholders.

4. The system of claim 1, wherein the research potential tracker further comprises code for:
identifying one or more potential research contributors for each subset.

5. The system of claim 4, wherein the research potential tracker further comprises code for:
ranking said potential research contributors based upon a potential research contribution index.

6. The system of claim 4, wherein the research potential tracker further comprises code for:
selecting a top research contributor from said one or more potential research contributors.

7. The system of claim 6, wherein the research potential tracker further comprises code for:
transmitting data from said research challenge database to the top research contributor.

8. The system of claim 1, further comprising a research challenge database in operative communication with said computer processor and comprising data representative of: said business value of each subset, said one or more stakeholders of each research problem in each subset, and a description of each research problem in each subset.

9. The system of claim 6, wherein the research potential tracker further comprises code for:
updating said research challenge database with data representative of: said business value of each subset, said one or more stakeholders of each research problem in each subset, and a description of each research problem in each subset.

10. A method for dynamic ongoing discovery of research problems, comprising the steps of:
grouping a plurality of subsets of said plurality of research problems based upon predetermined similarities amongst them;
removing a research problem from a subset when said research problem has a time frame extending beyond a predetermined time frame threshold;
computing a business value and research potential index for each said subset;
comparing each said research potential index against a predetermined research potential threshold; and
determining one or more stakeholders within said enterprise if said research potential index exceeds said predetermined research potential threshold.

11. The method of claim 9, further comprising the step of:
grouping said plurality of research problems in each subset based upon a time frame category.

12. The method of claim 8, further comprising the step of:
discounting said business value for a subset when a research problem is removed from said subset.

13. The method of claim 8, further comprising the step of:
identifying one or more potential research contributors for each subset.

14. The method of claim 8, further comprising the step of:
ranking said potential research contributors based on a potential research contribution index.

15. A computer program product providing content on multiple virtual displays, the computer program comprising a computer readable storage medium having program instructions embodied therewith, wherein the computer readable storage medium is not a transitory signal per se, the program instructions are readable by a computer to cause the computer to perform a method comprising the steps of:
grouping a plurality of subsets of said plurality of research problems based upon predetermined similarities amongst them;
computing a business value and research potential index for each said subset;
comparing each said research potential index against a predetermined research potential threshold;
determining one or more stakeholders within said enterprise if said research potential index exceeds said predetermined research potential threshold.

16. The method of claim 12, further comprising the step of:
grouping said plurality of research problems in each subset based upon a time frame category.

17. The method of claim 12, further comprising the step of:
matching each research problem in each subset with said one or more stakeholders.

18. The method of claim 12, further comprising the step of
identifying one or more potential research contributors for each subset.

19. The method of claim 18, further comprising the step of
ranking said one or more potential research contributors based on a potential research contribution index.

20. The method of claim 18, further comprising the step of
selecting a top research contributor from said one or more potential research contributors.
